(19) United States
(12) Patent Application Publication
(10) Pub. No.: US 2019/0295186 A1
(43) Pub. Date: Sep. 26, 2019

(54) SOCIAL NETWORKING SYSTEM FOR STUDENTS

(71) Applicant: Duona Zhou, WenZhou (CN)

(72) Inventor: Duona Zhou, WenZhou (CN)

(21) Appl. No.: 15/933,566

(22) Filed: Mar. 23, 2018

(51) Int. Cl. G06Q 50/00; G06Q 50/20; H04L 12/58; H04L 29/08; G06F 17/30

(52) U.S. Cl. CPC G06Q 50/01; G06Q 50/20; G06F 17/30867; H04L 67/306; H04L 51/32

(57) ABSTRACT

The present invention is an interactive social networking system which enables the students to create personal profile pages and access to the educational services system. The educational services system is accessible to the plurality of students by communication network. The system enables the students to find and join the students with common educational criteria. A mobile application enables the students to interact with one another by communications network. The present invention is an independent course selection system which is able to collect course information comprising: the capacity of the selected course, the number of the users who are waiting for space, provide a table of the trend as the predictions of the possible enrolment capacity number from the institutions. The system adds automatically updated course information to student's school system and the system will update the status of the course and send the notification to students.

### FIELD OF THE INVENTION

The present invention relates in general to the social networking systems and in particular to the social networking for students in educational institutions, universities, colleges, schools, etc.

### BACKGROUND OF THE INVENTION

Mobile applications are powerful communication means that can be used in a wide variety of environments, including in education environment. Such applications can resolve the need of students to communicate with each other, registration needs, course information, including various information about each class offering, such as times of the courses, the instructors, availability information, location, student interaction needs and various other information.

These applications have become increasingly popular, and many schools and students have begun to realize the benefits of such applications in sharing files and connecting with classmates. A drawback, however, is that these applications are not targeted to a specific group of students or a specific educational institution. Most of the systems require a significant amount of time and effort to learn and use. Students, for example, looking to register in a popular course, may have to spend hours on the institutions web sites. Each educational institution has limited space for each course, therefore, students who are looking for registering in a course, have to check the website of the institution every day in order to register the course. The unlucky students who are not successful to register for the course may not be able to graduate on time or may be forced to select another less desirable class.

What is needed, therefore, is a mobile application for students to interact with one another in connection with their common interests in an educational environment. A desirable application needs to be independent of the institutional system, in which students with common interests may connect with one another and experience a more balanced and leveled approach to education.

### SUMMARY OF THE INVENTION

The present invention is an interactive social networking system, which enables the students who are taking the same courses to interact with each other and share their experiences in their areas of interest. The present online social networking system enables the students to create personal profile pages and access the educational services system. The educational services system is accessible to the plurality of students by a communication network. The system enables the students to find and join other students with common educational criteria.

In one aspect of the present invention, each student has his own profile and enters the information about courses he/she has taken in each semester and the courses that he/she plans to take in the next semesters, and records the total credit that will be earned. The system has a server, including a profile builder that is configured to enable a user of the system to create a personal profile page including personal information. Such personal information may include username, a personal password, an identity of a school attended by the user, area of study, class schedule and the total credit each user earned. Plurality of the users create a social networking group in accordance with the educational criteria entered into the application by the user.

The present invention is an independent course selection system, which is able to collect course information from institutions and the networking group and automatically updates these information. The information includes: the capacity of the selected course, the number of the users who are waiting for space, provide a table of the trend as the predictions of the possible enrolment capacity number. The system automatically sends notifications to the students.

The present system also provides other potential courses, which have similar contents according to the profile information of each user. Other potential courses will be selected based on content, course description or level of difficulty.

In another aspect of the present invention, each educational institution can have its own social networking mobile App. These systems can communicate with each other to enable the user to obtain information from other educational institutions, send and receive course information and communicate with students from other institutions.

The system comprises of a database, which is in communication with the system server comprising a non-transient machine-readable medium for storing information related to the operation of the educational services system, including storing the personal profile page created by the user.

In another aspect, the present invention provides a chat platform in which the students can find the classmates who have already registered in the specific course and obtain information about the course. Students can share their files and images with each other. The mobile application also contains all information about each course, which will be collected from institutions website. The student can use keywords to find classes and classmates, even if they are not in the same school. Students can also sync course list to the school system.

In another alternative aspect, each of the students may specify whether or not other students can access the information associated with the personal profile page of the user.

In another aspect, plurality of employees or teachers have access to the information through the social networking system. The employers/teachers can find suitable candidates/positions easily and quickly based on educational criteria of each student that matches their requirements. Students can also enter the job market smoothly. The present invention comprises a grading system which rates the students automatically based on the courses attended on their school years, interests and skills, the GPA based on the information on their profile, and perform a grading list of the users on the system. The students who are searching for part time or full time jobs, employers who are searching for employees and teachers can benefit from this system.

Therefore, it is an object of the present invention to provide a mobile application that facilitates collaborative communications between students in an educational institution, but it is independent of that institution's website or app.

It is another object of the present invention to provide a list of students who take the same course. Therefore, users can compare their course schedules and select and follow the users that best match them.

It is another object of the present invention to assist students to enroll in their desired course faster and notify students when the selected course is open for registration.

It is another object of the present invention, to allow students access to the course information and their classmates, even if the student transfers to another institution.

It is another object of the present invention to provide online translation for international students.

It is another object of the present invention to assist the students to find part time or full-time jobs and the employers to hire the student based on the specific courses that they need to complete as a hiring requirement.

It is another object of the present invention to provide a system that an educational institution can use to determine the number of students that are interested in a particular course. This will allow them to decide whether a new class or a larger class is needed in that period.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows is a perspective block diagram of a mobile based social networking system;

FIG. 2 is a perspective block diagram of one aspect of the present invention, wherein the system manages a classmate interaction group;

FIG. 3 is a perspective block diagram of another aspect of the present invention, wherein the system manages a course registering, and

FIG. 4 is a perspective block diagram of another aspect of the present invention, wherein the system manages a student grading.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The method disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

This invention relates to connecting targeted users using a mobile application to enable communication and services between the connected users. Connected users are university/college students, teachers, employers, etc.

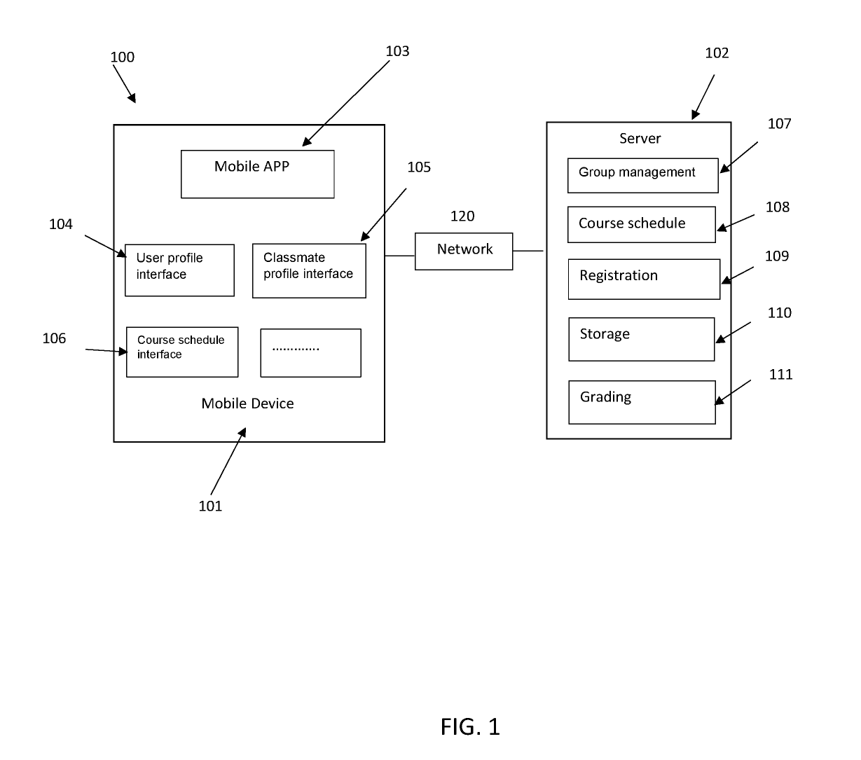

FIG. 1 is a perspective block diagram of a social networking system for university and college students 100. The system comprises a mobile device 101 communicatively coupled to a server 102. The mobile device 101 comprises a social networking mobile app 103 capable of receiving information's of a plurality of users of the app. Each user creates a user profile 104 and participates in group activities with other members of the group 105, course registering and other user interaction with the follow-up activities that are provided to a user after the user takes a course. A course schedule interface 106 is provided, which shows a list of courses. The users can access to a list of all courses, add a specific course and have access to other user's profile and their course schedules.

In operation, users provide a plurality of information on their profile page 104 by downloading the social networking mobile app 103. Specifically, the information includes: school year of the student, schedule of the student and courses registered in, courses interested in to be taken in the next semester, courses in the waiting list and users goals and preferences. The student information may also include, colleges attended by the student, actual and predicted graduation dates.

The user profile 104 may provide a privacy setting. Privacy settings may be global or individual to particular profile elements and may include: private (available to the specific users only), friends/classmates only, employers only, or public.

Preferably, the network 120 is a social network administered by one or more servers 102 which support posting and hosting and activity stream items, making connections among users, user profile pages, and access to educational materials, news from educational institution and downloadable materials available in the server 102.

In one aspect of the present invention, the server 102 comprises a group management system 107 to search for classmates who have same interests based on their profile information and creates and manages the group. Students use the social network system 100, to engage in learning opportunities with other students. As will be appreciated, that increased engagement will be correlated to increase learning, which further correlates to higher grades and greater job opportunities. Students may use the social network system 100 to study, contribute, help others, get help, receive job offers, receive teacher recommendations and suggest course improvements.

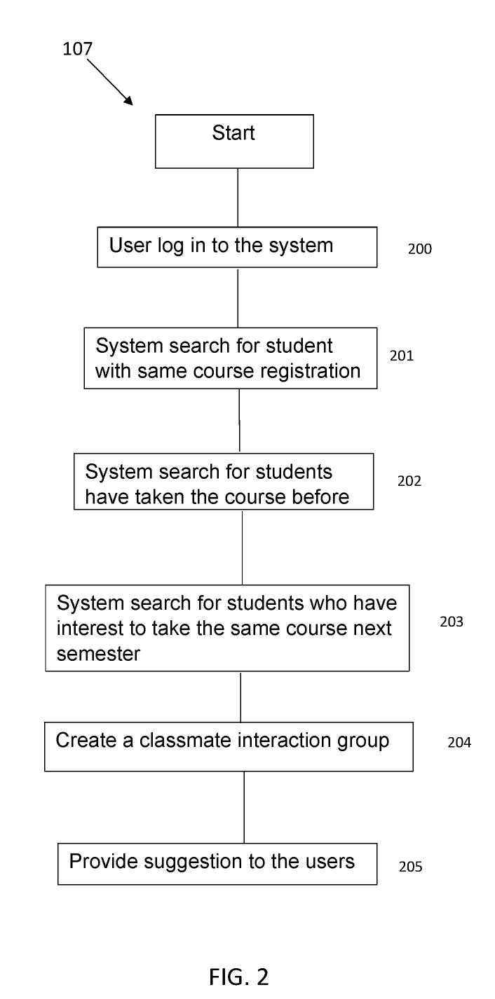

FIG. 2 shows the group management platform 107 in which the users of the system 100 interact with each other. After a student logs into the system, step 200, the system searches for users with the same course selections 201 and creates a classmate interaction group 204. The users include, users who are taking the specific course 202, as well as, users who will possibly take this course in the future 203.

The system suggests connections to the users 205 based on their common course selections. The students will have access to their classmate's profile, interact with each other about the courses and share their information through their classmate interaction interface 105.

In another aspect of the present invention, the social networking system 100 comprises of a course schedule interface 106, which comprises of courses provided by the institutions, the capacity of the courses; the number of the students who are waiting for a space in a course; provide a table showing the trend as a prediction of the possible enrolment capacity and number. The system builds a customized course schedule for the user in accordance with the present invention, wherein the customized course schedule is formed based on the profile information of each student and the course schedule of the educational institutions gathered and stored in the server and delivered to the user's mobile phone as desired.

The above operation is set forth through the course scheduling system 108. The information of each user according to the courses selected in student profile comprises: course title, capacity and pre-enrol requirement course list from the past, current and future (future may mean the next three terms), the total credit each user earned and courses that each student needs for graduation. The system can change the status of each course at any time in users profile system and will update the status of the course to the Enrol/Not enrol status. The system automatically registers the user if a spot is open for a course and sends a notification to the users.

Users can view other users' current course schedule, then user can decide whether to follow this user or not. The users not only can add friends who are taking this course but also can add the friends who will possibly take this course in the future.

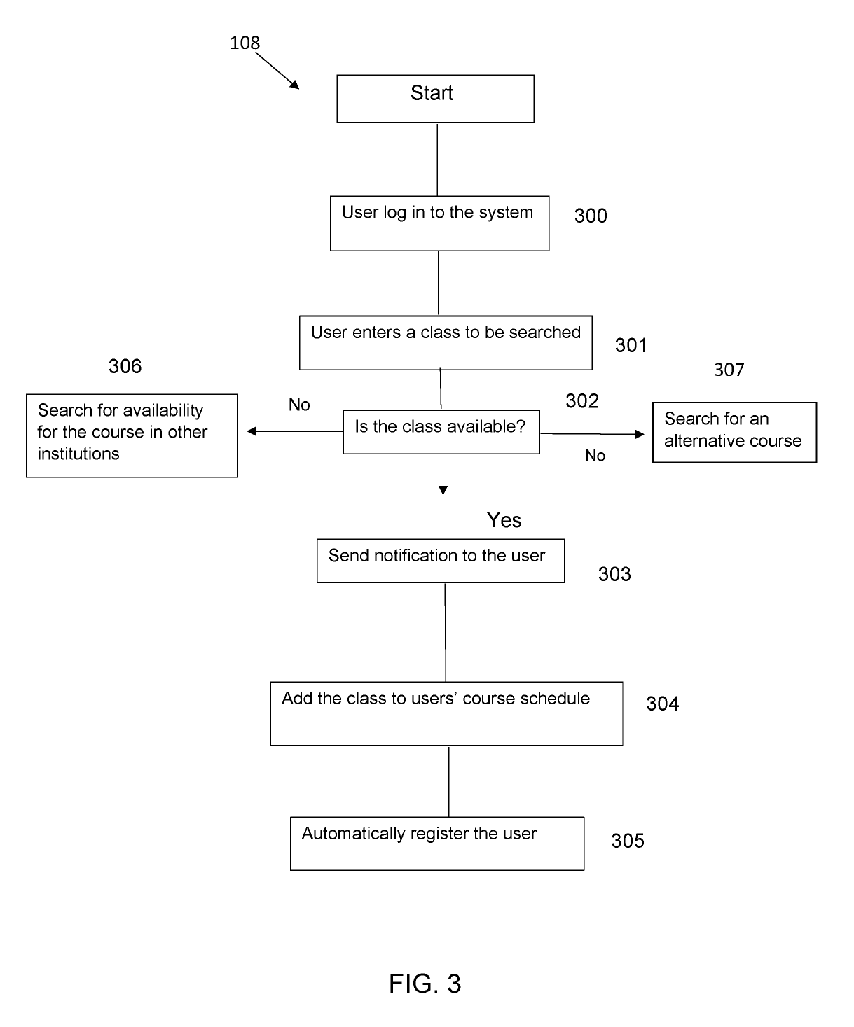

The operation to search for an opening in a course and automatically registering the student is shown in FIG. 3. The first step is to determine when a class opens for registration and inform the student via cell phone, email, text message, or any other method the user desires.

After the user logs into the system 300 and enters the desired class 301, the course schedule system 108 uses institution's database to determine if the class is available 302. If the system determines that the class entered in student's profile is available for registration, then the system sends notifications to the user 303. the system adds the class to the user's schedule 304. The system automatically registers the user in the course 305. If the class to be searched is not available in the specific institution the system performs searching for that class in other institutions and provides suggestions to the user 306.

The process continues, and the system determines if any classes remain in the student's database 301. The procedure returns to step 301 and obtains the next class. If the system determines that there are not any classes remaining in the student's database, then the system will automatically arrange a course schedule based on student's profile and ends the procedure for that particular student. The system will automatically recommend a course schedule based on user's major, grade level, classes taken, interests, etc.

In another aspect the system selects a plurality of alternative courses 307 that match with the mandatory courses a student requires for a graduating program based on the information's gathered from students profile page. System suggests the selected courses to the student and if the student accepts to replace the selected courses, the system will register the student in that course.

The search system and search algorithm are customized for each university's system. The system can be programmed to search in a number of ways such as directly from the university's public access website, from the university's private class database using any number of database technologies and will allow the system to search for available classes.

The search process activates at a specific time each day or only during specific hours of the day. If multiple classes are in the user's database, then the system obtains the next class. If multiple classes are not in the user's database, then the system obtains the same class and checks to see if the class is available. After the system determines the class is available, the system automatically registers the student for the class.

According to FIG. 1 again the server 102 further comprises of a registration system 109 that is used to automatically register selected students for one or more course based on their profile information. The registration system 109 automatically identifies other users of the system who may be interested in communicating with each other based on the student's course registration. The students provide information of their desired course to their profile system 104 regardless of the course being full or not. Such users are suggested to the student and are added as connections on the student's profile if the student and the users accept the suggestion. Connected students and users are enabled to communicate with each other within the platform. The system identifies other users via the course selections, wherein the other users may be interested in communicating with the student.

According to FIG. 1 again the system includes storage system 110 on a server. The system may include information such as, materials taught in a course, colleges or universities offering the course and teachers teaching the courses. The storage further stores contents including text, image, video or audio, such as but not limited to posts, comments, likes, tags, ratings, questions, answers and articles. The information provided in this section is gathered from the institution's web site and a rating is provided based on the individual ratings on each area provided by a plurality of users. For example, ratings for teachers, courses, majors, departments, etc., and classes offered at the college, rankings or ratings for the class or the teacher associated with the course. The storage may include institutional news, information about events, etc.

A popular course may be offered by several universities. The system identifies such universities or students associated with the course at each identified university. The system suggests the identified users at the other identified universities as connections to the student based on the information of user's profile. Users of the system that have a common course or a common teacher, and who the system identifies as users interested to have communications, will be connected to each other. Additionally, users registered for the same course at a university or across several universities may be interested in interacting with each other to learn from each other and obtain course materials to and from each other.

According to FIG. 1 again in another aspect, the present invention comprises a grading system 111, which rates the students automatically based on their courses attended on their school years, interests and skills, the GPA based on the information on their profile, and perform a grading list of the users of the system. This can be used for matching students with same level in the interaction group, suggesting alternative courses that are in the same level of difficulty.

The grading system further benefits employers who are searching for employees and teachers of educational institutions. The system analyzes and organizes a list of students with common relations with the employers and enables matching between students and job opportunities associated with employers. Teachers and professors can choose their graduate students who better fulfill their research programs in the universities. The employers or teachers can choose suitable candidates from among the students as per their requirements.

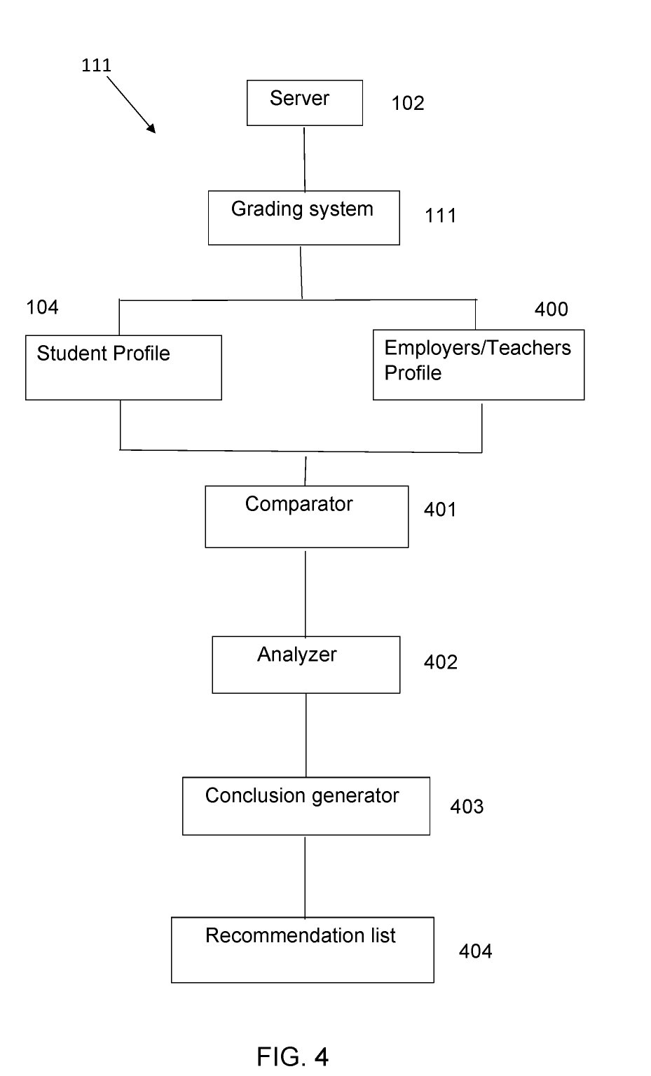

According to FIG. 4, the grading system 111 comprises a comparator 401 to compare users profile including student's profile 104 and employers/teachers profile 400 to determine common relations between them. An analyzer 402 generates a relation to match the perfect candidates among the students to the employers or teachers. The relation may be obtained from an algorithm to represent the relations among the users in the network. For example, the comparator 401 may be used to determine whether a user has an interest in a specific topic. This will be determining through the posts, comments and likes of the user and later use is an employer searching for someone with special interest.

The analyzer 402 further analyzes the information and generates conclusions about the users of the social network system 100. A conclusion may comprise detailed information about the user's education criteria, including, activity and interaction statistics as well as general psychological and sociological measures based on activities performed by the user.

The analyzer 402 further provides a set of reasons, and the reasons are aggregated to draw conclusions. The conclusions further assist the conclusion generator 403 of the system 111 to connect the users. The grading system 111 recommends one or more students to an employer 404.

The grading system 111 have also benefit for the students to measure where they stand, which courses are more beneficial for them to take in the future that may be of interest of the employers and improve the employment and educational system.

The social network system 100 further suggests a group of teachers and professors based on student's interest by gathering plurality information's and reviews of the social networking environment. This information is gathered from the student's feedbacks in the system or a plurality of review and rating sources such as Rate My Professors or other institutions websites. The system 100 analyses the teacher's reviews based on specific keywords and makes suggestions. For example, for teachers who take easy exams. Those students who are looking for a teacher whose exams are easy and they can get a higher grade can choose this class. The students can take classes with professors who have positive reputations, and consequently avoid those with poor reviews and prevent of issues which might be negatively affecting their grades.

The system 100 further provides a rating system. The user can rate courses in course detail interface in the app. The system will record the total credit each user earned, which will show up on the user's profile.

In another aspect, the present invention may be use in life activities. Users may post new life experiences and activities they experienced best places they visited on campus or in the city of residence and announcements related to searching for roommates to rent a room on campus.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A social networking platform for screening, selecting, scheduling and registering, comprising:
a) a screening computer-program implemented to screen an entire gathered data from an environment, wherein said environment comprising of a student, a group-of-students forming an interaction group, a group-of-teachers, and a group-of-employers, based on a set of common relations;
b) a first-set-of-requirements comprising a plurality of mandatory courses provided by an educational institution;
c) a second-set-of-requirements comprising a plurality of alternative courses provided by said interaction group;
d) a first-selecting-computer-program implemented to select said plurality of mandatory courses based on said first-set-of-requirements;
e) a second-selecting-computer-program implemented to select said plurality of alternative courses based on said second-set-of-requirements;
g) a suggesting-computer-program implemented to suggest said plurality of alternative courses to said student to replace an unavailable course;
h) a grading-computer-program implemented to rate said student;
i) a ranking-computer-program implemented to rank said alternative courses and match said alternative courses with said mandatory courses and said grading of said student, wherein said alternative courses are suggested to said student,
j) a registering-computer-program implemented to register said student;
k) a first-executing-computer-program implemented to find said group-of-students with common relations to interact in said interaction group;
l) a second-executing-computer-program implemented to match a plurality employers and teachers with common relations to interact in said interaction group;
m) a recommending-computer-program implemented to recommend a course schedule to said student, and
n) a main database to collect data from said screening, first-selecting, second-selecting, suggesting, grading, ranking, registering, first-executing, second-executing and recommending computer-programs.

2. The social networking platform of claim 1, wherein said mandatory requirements selected from a group of courses each student requires for a graduating program.

3. The social networking platform of claim 1, wherein said optional requirements selected from a group of courses selected and offered to each student based on a set-of-elements gathered from said environment.

4. The social networking platform of claim 1, wherein said common relations in said interaction group being selected from a group of relations comprising: courses attended by said student, a school year of said student, a course schedule of said student, a set of courses said student registered or interested in, a set of goals and preferences of said student, a list of colleges said student attended with graduation date, work experiences and skills of said student.

5. The social networking platform of claim 1, wherein said screening computer-program collects a set of information from said environment and stores said set of information in said main database.

6. The social networking platform of claim 1, wherein said ranking of said mandatory requirements and said optional requirements are based on a set-of-elements being course hardness or easiness, the instructor of said course, time, date and location of said courses.

7. The social networking platform of claim 1, wherein said grading of said student is based on a set of elements consisting of courses said student attended, interests and skills of said student and GPA of said student.

8. The social networking platform of claim 1, wherein said platform include a profile builder configured to enable each said student of said interaction group create a personal profile page, and a downloadable application for joining and/or creating said interaction group.

9. The social networking platform of claim 1, wherein said suggesting computer-program reviews and compares said plurality of alternative courses with said plurality mandatory courses and selects said plurality alternative courses that can be replaced with said mandatory courses, whereby in case of said mandatory courses being unavailable said student can select said alternative courses.

10. The social networking platform of claim 1, wherein said platform has a notification system to notify said members in said interaction group.

11. The social networking system of claim 1, wherein said platform provides a privacy setting, wherein said privacy setting being a global privacy setting or an individual privacy setting.

12. The social networking platform of claim 1, wherein said information gathered from said educational institutions comprising: the capacity of selected courses, the number of students who are waiting for space for a course and the enrollment capacity number.

13. A method for screening, selecting, scheduling and registering in a social networking platform comprising steps of:
a) screening entire gathered data from an environment for an interaction group; said interaction group being a group of students in an educational institution with common relations;
b) selecting a plurality of mandatory courses based on a first-set-of-requirements, wherein said first-set-of-requirements comprising of a plurality of mandatory requirements each student require for a graduation program;
c) selecting a plurality of alternative courses based on a second-set-of-requirements, wherein said second-set-of-requirements comprising of a plurality of alternative courses;
d) suggesting said plurality of alternative courses to said student to replace an unavailable course;
e) grading said student and suggesting said alternative courses based on each said grading of said student;
f) registering said student for said course in said educational institution;
g) executing said group-of-students based on said common relations to interact in said interaction group;
h) executing a plurality of said teachers and said employers with common relations to interact in said interaction group, and
i) recommending a course schedule to said student.

14. The method for screening, selecting, scheduling and registering of claim 13, wherein said mandatory requirements selected are courses each said student requires for a graduating program.

15. The method for screening, selecting, scheduling and registering of claim 13, wherein said optional requirements are a plurality courses selected and offered to each said student based on a set-of-elements gathered from said environment.

16. The method for screening, selecting, scheduling and registering of claim 13, wherein said screening comprises steps of:
a) collecting a set of information from said educational institution;
b) collecting a set of information from said interaction group;
c) collecting a set of information from said social media websites, and
d) storing said set of information in said main database.

17. The method for screening, selecting, scheduling and registering of claim 13, wherein said first-selecting comprises steps of:
a) reviewing said set of information;
b) comparing said set of information with said first-set-of-requirements, and
c) selecting a plurality of said courses.

18. The method for screening, selecting, scheduling and registering of claim 13, wherein said second-selecting comprises steps of:
a) reviewing said set of information;
b) comparing said set of information with said second-set-of-requirements, and
c) selecting a plurality of said second-courses.

19. The method for screening, selecting, scheduling and registering of claim 13, wherein said platform independently connects to a plurality of educational institutions and is able to collect course information from said institutions.
